(19) United States
(12) Patent Application Publication
(10) Pub. No.: US 2025/0007288 A1
(43) Pub. Date: Jan. 2, 2025

(54) SIGNAL TRANSITION TIME TUNING TO REDUCE VOLTAGE RINGING

(71) Applicant: TEXAS INSTRUMENTS INCORPORATED, Dallas, TX (US)

(72) Inventors: James PERKINS, Leeds (GB); Daniel TOOTH, Edinburgh (GB)

(21) Appl. No.: 18/343,281

(22) Filed: Jun. 28, 2023

(51) Int. Cl. H02J 3/24

(52) U.S. Cl. CPC H02J 3/24

(57) ABSTRACT

Aspects of the disclosure provide for a method. In some examples, the method includes programming a rise time of a power converter control signal to a first value, programming a fall time of the power converter control signal to a second value, and executing a tuning operation loop. The tuning operation loop includes determining a first peak value of voltage ringing at a switch node of a power converter controlled according to the power converter control signal, incrementing the rise time and the fall time each by a programmed amount, determining a second peak value of voltage ringing at the switch node, comparing the first peak value to the second peak value, and responsive to the second peak value being less than the first peak value, repeating execution of the tuning operation loop.

### BACKGROUND

Voltage ringing results from transient oscillations of a voltage around a programmed or nominal value. The voltage ringing may result from operations inherent to a circuit, such as switching, or other changes in state of a component or signal, and may be related to a resonant frequency of the circuit. In some examples, that resonant frequency is affected by parasitic elements, such as parasitic inductance and/or parasitic capacitance of components of the circuit, interconnects of the circuit, etc.

### SUMMARY

In some examples, a method includes programming a rise time of a power converter control signal to a first value, programming a fall time of the power converter control signal to a second value, and executing a tuning operation loop. The tuning operation loop includes determining a first peak value of voltage ringing at a switch node of a power converter controlled according to the power converter control signal, incrementing the rise time and the fall time each by a programmed amount, determining a second peak value of voltage ringing at the switch node, comparing the first peak value to the second peak value, and responsive to the second peak value being less than the first peak value, repeating execution of the tuning operation loop.

In some examples, an apparatus is configured to provide a control signal having a programmed transition time. The apparatus is also configured to determine a value of voltage oscillations at a switch node of a power converter under control of the control signal. The apparatus is also configured to modify the transition time of the control signal based on a period of the voltage oscillations.

In some examples, a system includes a power converter and a controller coupled to the power converter. The controller is configured to provide a control signal having a programmed transition time to the power converter, determine a value of voltage oscillations at a switch node of power converter under control of the control signal, and modify the transition time of the control signal based on a reciprocal of a frequency of the voltage oscillations.

### BRIEF DESCRIPTION OF THE DRAWINGS

FIG. 1 is a block diagram of a system, in accordance with various examples.

FIG. 2 is a waveform diagram, in accordance with various examples.

FIG. 3 is a waveform diagram, in accordance with various examples.

FIG. 4 is a waveform diagram, in accordance with various examples.

FIG. 5 is a flow diagram of a method, in accordance with various examples.

FIG. 6 is a flow diagram of a method, in accordance with various examples.

FIG. 7 is a flow diagram of a method, in accordance with various examples.

FIG. 8 is a flow diagram of a method, in accordance with various examples.

FIG. 9 is a flow diagram of a method, in accordance with various examples.

### DETAILED DESCRIPTION

As described above, voltage ringing results from transient oscillations of a voltage around a programmed or nominal value. For example, inductor (L) capacitor (C) parasitics of a circuit may form an LC tank. One such circuit is a power converter. The LC tank may cause voltage ringing in the circuit. The voltage ringing may adversely affect operation of the circuit, such as increasing power consumption by the circuit, reducing efficiency of the circuit, increasing electromagnetic interference (EMI) emitted by the circuit, etc. In some examples, the circuit is a power converter, such as a step-down or buck power converter. In a power converter, an LC tank formed by parasitics at a switch terminal of the power converter may cause voltage ringing at the switch terminal responsive to switching of power transistors of the power converter. The voltage ringing may be at a frequency approximately equal to a natural frequency of the LC tank, creating EMI at that frequency. Some approaches exist to mitigate voltage ringing, such as snubber circuits. However, such approaches operate to mitigate voltage ringing after it has been formed, and in some circumstances can degrade performance of the power converter, such as by decreasing efficiency or increasing power consumption.

Examples of this description provide for reducing voltage ringing in a switched circuit. The switched circuit may be a power converter, for example. Voltage ringing resulting from an LC tank may occur at approximately a natural frequency of the LC tank. By reducing an amount of energy provided to the LC tank at that natural frequency, a magnitude of the voltage ringing may be reduced. For example, power transistors of a power converter are controlled to switch on or switch off under control of a control signal that causes a switch terminal waveform to be provided at the switch terminal. An ideal switch terminal waveform may be a square wave signal. However, such an ideal waveform may not be possible in practice resulting from time delays, parasitics, etc. As a result, the switch terminal waveform may appear as an approximately trapezoidal waveform. The trapezoidal waveform may be further altered based on voltage ringing, as described herein. The trapezoidal waveform has a rise time (T_{R}) during which the trapezoidal waveform transitions from a low-level signal to a high-level signal, and a fall time (T_{F}) during which the trapezoidal waveform transitions from a high-level signal to a low-level signal. In some examples, T_{R}=T_{F}. By modifying T_{R}, an amount of energy provided to the LC tank at its resonant frequency may be decreased. By decreasing the amount of energy provided to the LC tank at its resonant frequency, voltage ringing at the switch terminal may be reduced.

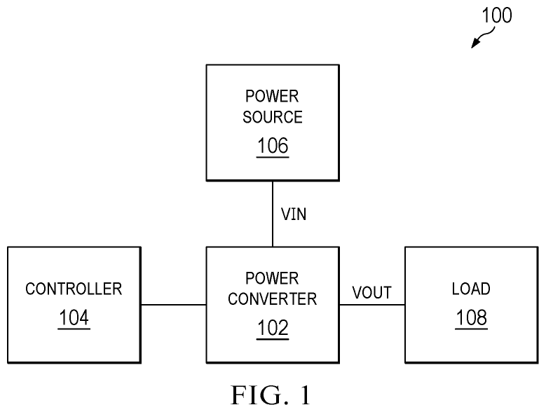

FIG. 1 is a block diagram of a system 100, in accordance with various examples. The system 100 may be generally representative of any device or system that includes a power converter. In various examples, the system 100 may be representative of an electronic device (e.g., a laptop computer, a desktop computer, a server computer, a smartphone, a wearable device, a health monitoring device, a wireless access point, or the like), an automobile, an aircraft, a spacecraft (e.g., satellite), or any other device including a power converter.

In an example, the system 100 includes a power converter 102, a controller 104, a power source 106, and a load 108. The controller 104 controls the power converter 102 to switch power from the power source 106 to the load 108. In examples in which the power converter 102 is a step-down power converter, the power converter 102 receives an input voltage (VIN) from the power source 106 having a first value and provides an output voltage (VOUT) to the load 108 having a second value, where the second value is less than the first value. In other examples, the power converter 102 may also, or alternatively, be a step-up power converter (such as a boost converter or buck-boost converter).

The controller 104 provides control signals that control components (not shown) of the power converter 102 to switch on and off at a switching frequency determined to cause VOUT to have a programmed value, such as based on a target or reference value received by the controller. For example, the greater the duty cycle, the larger the value of VOUT and the smaller the duty cycle the smaller the value of VOUT. Many different control schemes or methodologies may be suitable for controlling the power converter 102, and the controller 104 may take various architectural (e.g., hardware or structural) forms to implement these control schemes, the scope of which is not limited herein. In some examples, power lost in the switching operations (e.g., switching losses) may increase during a time in which the components (such as power transistors) of the power converter 102 are switching from on to off, or vice versa. In a power transistor, this time period May be referred to as a commutation time of the power transistor. To reduce the switching losses, it may be preferred to reduce the commutation time to a minimum time permitted by an architecture of the system 100, a process technology of the power transistors, or the like. However, the commutation time may be inversely proportional to the magnitude of the voltage ringing at the switch terminal. Thus, the faster the commutation time, and therefore reduced switching losses, the greater the magnitude of the voltage ringing. Conversely, the slower the commutation time, and therefore increased switching losses, the lesser the magnitude of the voltage ringing. Therefore, the controller 104 may strike a balance for a particular implementation of the system 100 between an acceptable level of switching losses and an acceptable magnitude of voltage ringing in determining values for control signals for the power transistors. For example, a rise time of the control signal may be proportional to T_{R} and a fall time of the control signal may be proportional to T_{F}.

In some examples, the controller 104 performs one or more measurements of a voltage provided at the switch terminal (Vsw) and, based on the measurement(s), modifies the control signal(s). For example, the controller 104 may measure a first value of Vsw, modify the control signal such as to increase T_{R} by an incremental amount T_{INC}, and then measure a second value of Vsw. Based on the relationship between the first and second values of Vsw, the controller 104 may further modify the control signal to increase or decrease T_{R} until a minimum, or approximately a minimum, value of Vsw is determined. By modifying the control signal to modify T_{R} until a minimum, or approximately a minimum, value of Vsw is determined, an amount of energy provided to the LC tank is reduced and a magnitude of voltage ringing caused by the LC tank is reduced. The decreased voltage ringing correspondingly results in reduced EMI emitted by the power converter 102.

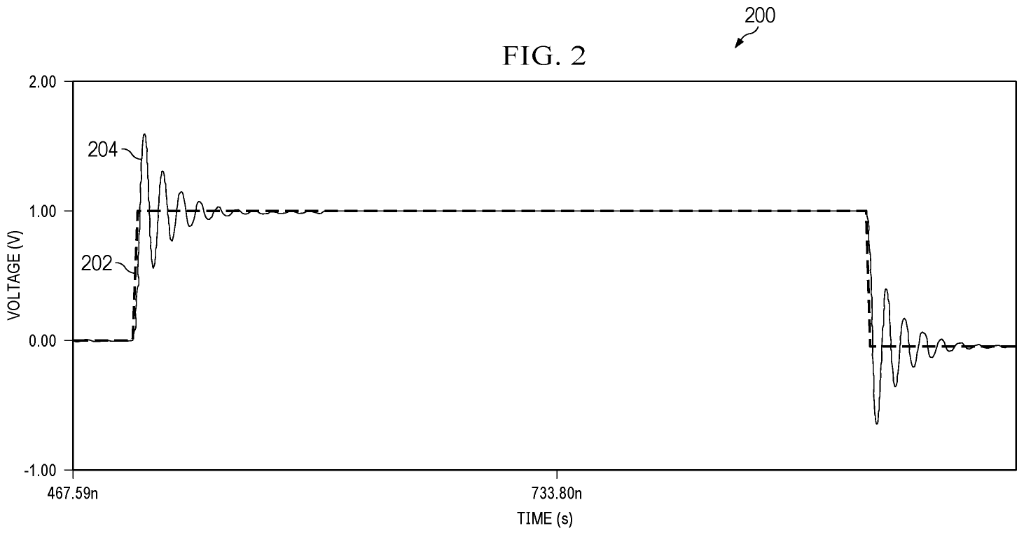

FIG. 2 is a waveform diagram 200, in accordance with various examples. The waveform diagram 200 includes a signal 202 and a signal 204. The signal 202 is representative of an ideal trapezoidal waveform for Vsw. The signal 204 is representative of a value of Vsw in the presence of voltage ringing. Both the signal 202 and the signal 204 are shown on a vertical axis representative of voltage in units of volts (V) and a horizontal axis representative of time in units of seconds(s). As shown by the signal 204, parasitics, such as an LC tank, in a system, such as the system 100, cause an oscillation of a voltage value around an ideal value, shown by the signal 202. This oscillation created EMI, which may have adverse effects on operation of the system in various application environments.

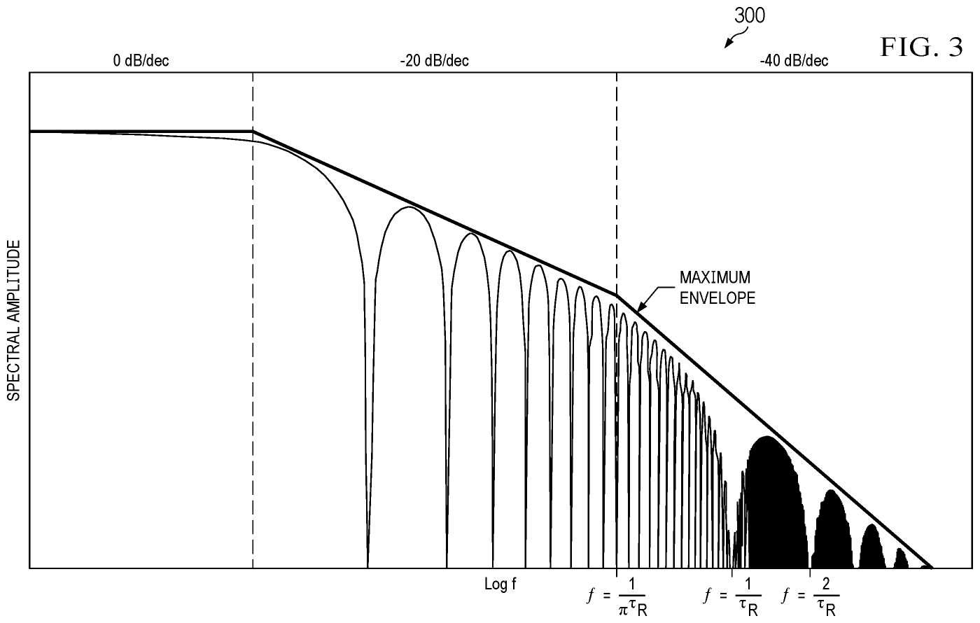

FIG. 3 is a waveform diagram 300, in accordance with various examples. The waveform diagram 300 is representative of a frequency spectrum of Vsw and is shown having a vertical axis representative of amplitude in units of decibels (dB) and a horizontal axis representative of a frequency of Vsw, shown on a logarithmic scale. As shown by the waveform diagram 300, Vsw has a minimum energy at frequencies of N/T_{R}, where N is a positive whole number greater than 0. Thus, by the controller 104 controlling the control signal provided to the power converter 102 to have a greater transition time, T_{R} is increased. By increasing T_{R} to cause N/T_{R} to have a value approximately equal to a natural frequency (Fosc) of parasitics (such as an LC tank) in the power converter 102, ringing caused by the parasitics, and corresponding EMI emission at Fosc, are reduced.

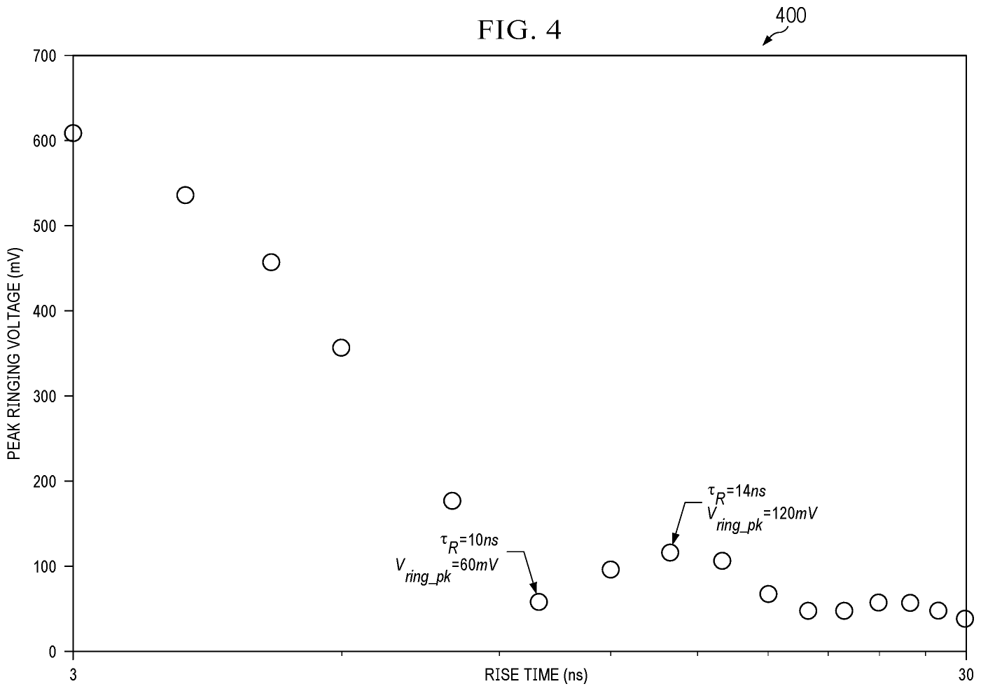

FIG. 4 is a waveform diagram 400, in accordance with various examples. The waveform diagram 400 is a scatter plot of values, in units of millivolts (mV) of the peak of the Vsw oscillation component across various values of T_{R}. As shown by the waveform diagram 400, as T_{R} increases in value, a peak value of the Vsw oscillation component decreases in value until a first minima is reached at T_{R}=1/Fosc. As T_{R} further increases in value, a peak value of the Vsw oscillation component first increases and then decreases in value until a second minima is reached at T_{R}=2/Fosc. The above pattern repeats as T_{R} increases with minimas appearing at T_{R}=N/Fosc. Thus, by controlling T_{R} to increase to T_{R}=1/Fosc (or T_{R}=N/Fosc), the peak value of Vsw is decreased and EMI emissions at Fosc are decreased.

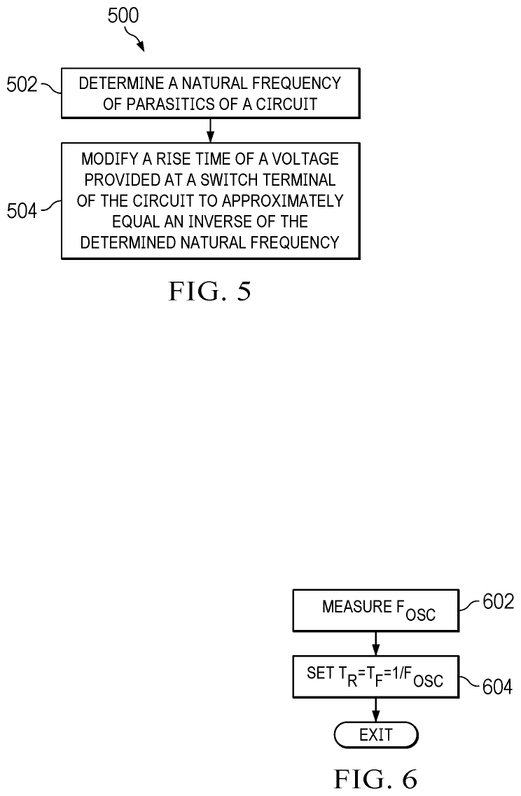

FIG. 5 is a flow diagram of a method 500, in accordance with various examples. In an example, the method 500 is a method of reducing voltage ringing in a circuit, such as a power converter. Reducing the voltage ringing may cause a corresponding reduction in EMI emission by the circuit. In some examples, the power converter is the power converter 102 of the system 100 of FIG. 1, and the method 500 is implemented at least in part by the controller 104.

At operation 502, a natural frequency of parasitics of a circuit are determined. The natural frequency, which may be referred to as Fosc, may be determined according to any suitable means, the scope of which is not limited herein. In some examples, the natural frequency is of a LC tank formed by parasitics of the circuit. In some examples, such as a power converter, the LC tank is present at a switch terminal of the power converter.

At operation 504, a rise time, which may be referred to as T_{R}, of a voltage provided at the switch terminal is modified to approximately equal an inverse of the determined natural frequency. For example, the controller 104 modifies a value of control signals provided to a power converter for forming Vsw to cause T_{R}=N/Fosc, where N is a positive whole number greater than 0. The controller may increase T_{R} by increasing a transition time (e.g., rise or fall) of the control signal(s).

FIG. 6 is a flow diagram of a method 600, in accordance with various examples. In an example, the method 600 is a method of reducing voltage ringing in a circuit, such as a power converter. Reducing the voltage ringing may cause a corresponding reduction in EMI emission by the circuit. In some examples, the power converter is the power converter 102 of the system 100 of FIG. 1, and the method 600 is implemented at least in part by the controller 104.

At operation 602, Fosc is measured. In some examples, Fosc is measure at a time of design of the circuit, or at a time of manufacture of the circuit. Fosc may be measured, for example, by coupling an oscilloscope to power converter 102 and directly observing, or measuring, Fosc. A corresponding T_{R} may be determined and stored for subsequent use by the controller 104 in controlling the power converter 102.

At operation 604, the controller is programmed to provide control signals to cause T_{R}=1/Fosc. In some examples, T_{R} as programmed at operation 604 may be hard-coded, or unchangeable by a user of the circuit. As such, the method 600 may be suitable for controlling T_{R}=N/Fosc in application environments in which Fosc remains substantially static or unchanging.

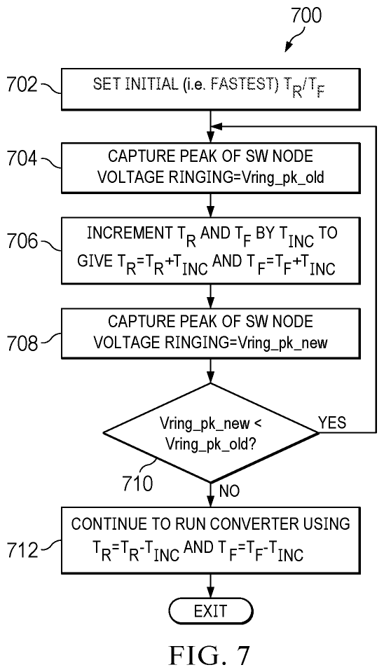

FIG. 7 is a flow diagram of a method 700, in accordance with various examples. In an example, the method 700 is a method of reducing voltage ringing in a circuit, such as a power converter. Reducing the voltage ringing may cause a corresponding reduction in EMI emission by the circuit. In some examples, the power converter is the power converter 102 of the system 100 of FIG. 1, and the method 700 is implemented at least in part by the controller 104.

At operation 702. T_{R} is set to an initial value based on control signals provided by the controller 104. The initial value may be, for example, a minimum value for which the controller 104 is programmed to provide the control signals.

At operation 704, the controller 104 measures a peak value of Vsw. The peak value of Vsw as measured at operation 704 may be referred to as Vring_pk_old. The controller 104 may measure the peak value of Vsw according to any suitable process, the scope of which is not limited herein. For example, the peak value of Vsw may be measured and/or determined by a peak detector circuit, by a sample and hold circuit, or any other suitable circuit.

At operation 706, the controller modifies the control signal(s) to increase T_{R} by an incremental amount T_{INC}. In some examples, T_{INC} is a value specified at a time of manufacture of the circuit and is unchangeable by a user of the circuit. In other examples, T_{INC} is a programmable value which may be specified or otherwise provided to the controller 104 by a user of the circuit.

At operation 708, the controller 104 measures a new peak value of Vsw. The peak value of Vsw as measured at operation 708 may be referred to as Vring_pk_new. The controller 104 may measure the peak value of Vsw according to any suitable process, the scope of which is not limited herein.

At operation 710, the controller compares Vring_pk_new to Vring_pk_old to determine whether Vring_pk_new is less than Vring_pk_old. Responsive to Vring_pk_new being less than Vring_pk_old, the method 700 returns to operation 704. Responsive to Vring_pk_new not being less than Vring_pk_old, the method 700 proceeds to operation 712.

At operation 712, the controller modifies the control signal(s) to decrease T_{R} by T_{INC}.

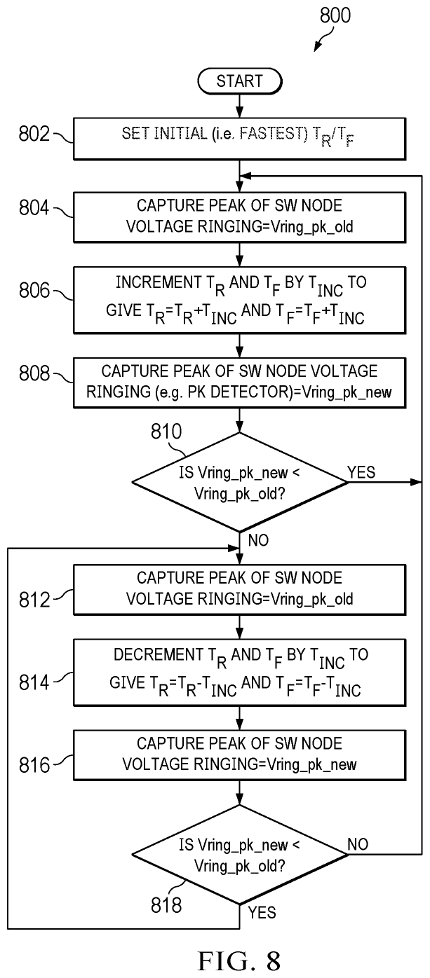

FIG. 8 is a flow diagram of a method 800, in accordance with various examples. In an example, the method 800 is a method of reducing voltage ringing in a circuit, such as a power converter. Reducing the voltage ringing may cause a corresponding reduction in EMI emission by the circuit. In some examples, the power converter is the power converter 102 of the system 100 of FIG. 1, and the method 800 is implemented at least in part by the controller 104.

At operation 802, T_{R} is set to an initial value based on control signals provided by the controller 104. The initial value may be, for example, a minimum value for which the controller 104 is programmed to provide the control signals.

At operation 804, the controller 104 measures a peak value of Vsw. The peak value of Vsw as measured at operation 804 may be referred to as Vring_pk_old. The controller 104 may measure the peak value of Vsw according to any suitable process, the scope of which is not limited herein. For example, the peak value of Vsw may be measured and/or determined by a peak detector circuit, by a sample and hold circuit, or any other suitable circuit.

At operation 806, the controller 104 modifies the control signal(s) to increase T_{R} by an incremental amount T_{INC}. In some examples. T_{INC} is a value specified at a time of manufacture of the circuit and is unchangeable by a user of the circuit. In other examples, Tic is a programmable value which may be specified or otherwise provided to the controller 104 by a user of the circuit.

At operation 808, the controller 104 measures a new peak value of Vsw. The peak value of Vsw as measured at operation 808 may be referred to as Vring_pk_new. The controller 104 may measure the peak value of Vsw according to any suitable process, the scope of which is not limited herein.

At operation 810, the controller 104 compares Vring_pk_new to Vring_pk_old to determine whether Vring_pk_new is less than Vring_pk_old. Responsive to Vring_pk_new being less than Vring_pk_old, the method 800 returns to operation 804. Responsive to Vring_pk_new not being less than Vring_pk_old, the method 800 proceeds to operation 812.

At operation 812, the controller 104 measures a new peak value of Vsw. The peak value of Vsw as measured at operation 812 may be referred to as Vring_pk_old, replacing the peak value of Vsw captured at operation 804. The controller 104 may measure the peak value of Vsw according to any suitable process, the scope of which is not limited herein.

At operation 814, the controller 104 modifies the control signal(s) to decrease T_{R} by T_{INC}. In some examples, the controller 104 instead modifies the control signal(s) to decrease T_{R} by T_{INCn}, where T_{INCn} is less than T_{INC}. For example, the controller 104 may incrementally decrease the value of T_{INC} to form T_{INC2}, T_{INC3}, . . . , T_{INCn}, to cause the controller 104 to control the power converter 102 to converge on a minimum of the peak value of Vsw.

At operation 816, the controller 104 measures a new peak value of Vsw. The peak value of Vsw as measured at operation 816 may be referred to as Vring_pk_new, replacing the peak value of Vsw captured at operation 808. The controller 104 may measure the peak value of Vsw according to any suitable process, the scope of which is not limited herein.

At operation 818, the controller 104 compares Vring_pk_new to Vring_pk_old to determine whether Vring_pk_new is less than Vring_pk_old. Responsive to Vring_pk_new being less than Vring_pk_old, the method 800 returns to operation 812. Responsive to Vring_pk_new not being less than Vring_pk_old, the method 800 returns to operation 804.

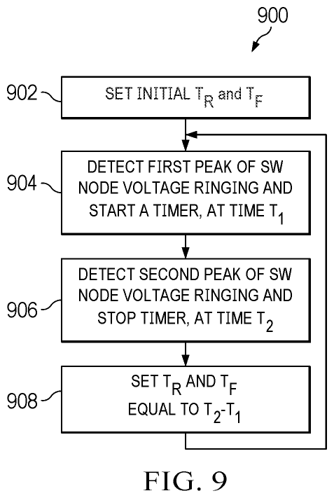

FIG. 9 is a flow diagram of a method 900, in accordance with various examples. In an example, the method 900 is a method of reducing voltage ringing in a circuit, such as a power converter. Reducing the voltage ringing may cause a corresponding reduction in EMI emission by the circuit. In some examples, the power converter is the power converter 102 of the system 100 of FIG. 1, and the method 900 is implemented at least in part by the controller 104.

At operation 902, T_{R} is set to an initial value based on control signals provided by the controller 104. The initial value may be, for example, a minimum value for which the controller 104 is programmed to provide the control signals.

At operation 904, the controller 104 detects a peak value of Vsw at a time T1 and begins a timer. The controller 104 may detect the peak value of Vsw according to any suitable process, the scope of which is not limited herein. For example, the peak value of Vsw may be measured and/or determined by a peak detector circuit, by a sample and hold circuit, or any other suitable circuit.

At operation 906, the controller 104 detects a second peak value of Vsw at a time T2 and stops the timer begun at operation 904. The controller 104 may detect the peak value of Vsw according to any suitable process, the scope of which is not limited herein.

At operation 908, the controller 104 modifies the control signal(s) to specify T_{R} as having a value or count of the timer following stopping of the timer at time T2 in operation 906.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A method, comprising:
programming a rise time of a power converter control signal to a first value;
programming a fall time of the power converter control signal to a second value; and
executing a tuning operation loop including:
determining a first peak value of voltage ringing at a switch node of a power converter controlled according to the power converter control signal;
incrementing the rise time and the fall time each by a programmed amount;
determining a second peak value of voltage ringing at the switch node;
comparing the first peak value to the second peak value; and
responsive to the second peak value being less than the first peak value, repeating execution of the tuning operation loop.

2. The method of claim 1, wherein responsive to the second peak value not being less than the first peak value, the method includes:
decrementing the incremented rise time and fall time; and
controlling the power converter to perform switching according to the power converter control signal having the rise time and fall time.

3. The method of claim 1, wherein the programmed amount is less than each of the rise time and the fall time.

4. The method of claim 1, wherein modifying the rise time and the fall time of the power converter control signal based on a measured peak value of voltage ringing at the switch node reducing electromagnetic interference radiated by the power converter.

5. The method of claim 1, wherein responsive to the second peak value not being less than the first peak value, the method includes executing a second tuning operation loop including:
determining a third peak value of voltage ringing at the switch node;
decrementing the rise time and the fall time each by the programmed amount;
determining a fourth peak value of voltage ringing at the switch node;
comparing the third peak value to the fourth peak value;
responsive to the fourth peak value being less than the third peak value, repeating execution of the second tuning operation loop; and
responsive to the fourth peak value not being less than the third peak value, repeating execution of the tuning operation loop.

6. An apparatus, configured to:
provide a control signal having a programmed transition time;
determine a value of voltage oscillations at a switch node of a power converter under control of the control signal; and
modify the transition time of the control signal based on a period of the voltage oscillations.

7. The apparatus of claim 6, wherein the transition time is one of a rise time or a fall time.

8. The apparatus of claim 6, wherein to determine the value of voltage oscillations and modify the transition time of the control signal, the apparatus is configured to implement a tuning operation loop including:
determining a first peak value of the voltage oscillations;
incrementing the transition time by a programmed amount;
determining a second peak value of the voltage oscillations;
comparing the first peak value to the second peak value;
responsive to the second peak value being less than the first peak value, repeating execution of the tuning operation loop; and
responsive to the second peak value not being less than the first peak value, decrementing the transition time by the programmed amount.

9. The apparatus of claim 8, wherein the programmed amount is less than the transition time.

10. The apparatus of claim 8, wherein decrementing the transition time based on the determined value of voltage oscillations at the switch node reduces electromagnetic interference radiated by the power converter.

11. The apparatus of claim 8, wherein responsive to the second peak value not being less than the first peak value, the apparatus is configured to execute a second tuning operation loop including:
determining a third peak value of the voltage oscillations;
decrementing the transition time by the programmed amount;
determining a fourth peak value of the voltage oscillations;
comparing the third peak value to the fourth peak value;
responsive to the fourth peak value being less than the third peak value, repeating execution of the second tuning operation loop; and
responsive to the fourth peak value not being less than the third peak value, repeating execution of the tuning operation loop.

12. The apparatus of claim 6, wherein determining the value of the voltage oscillations includes determining that the voltage oscillations are at a first peak value at a first time and determining that the voltage oscillations are at a second peak value less than the first peak value at a second time, and wherein modifying the transition time of the control signal includes setting the transition time to equal a difference between the second time and the first time.

13. The apparatus of claim 12, wherein the apparatus is configured to begin a timer responsive to determining that the voltage oscillations are at the first peak value at the first time, and stop the timer responsive to determining that the voltage oscillations are at the second peak value at the second time, and wherein a count value of the timer is the difference between the second time and the first time.

14. A system, comprising:
a power converter; and
a controller coupled to the power converter, wherein the controller is configured to:
provide a control signal having a programmed transition time to the power converter;
determine a value of voltage oscillations at a switch node of power converter under control of the control signal; and
modify the transition time of the control signal based on a reciprocal of a frequency of the voltage oscillations.

15. The system of claim 14, wherein to determine the value of voltage oscillations and modify the transition time of the control signal, the controller is configured to implement a tuning operation loop including:
determining a first peak value of the voltage oscillations;
incrementing the transition time by a programmed amount;
determining a second peak value of the voltage oscillations;
comparing the first peak value to the second peak value;
responsive to the second peak value being less than the first peak value, repeating execution of the tuning operation loop; and
responsive to the second peak value not being less than the first peak value, decrementing the transition time by the programmed amount.

16. The system of claim 15, wherein decrementing the transition time based on the determined value of voltage oscillations at the switch node reduces electromagnetic interference radiated by the power converter.

17. The system of claim 15, wherein responsive to the second peak value not being less than the first peak value the system is configured to execute a second tuning operation loop including:
determining a third peak value of the voltage oscillations;
decrementing the transition time by the programmed amount;
determining a fourth peak value of the voltage oscillations;
comparing the third peak value to the fourth peak value;
responsive to the fourth peak value being less than the third peak value, repeating execution of the second tuning operation loop; and
responsive to the fourth peak value not being less than the third peak value, repeating execution of the tuning operation loop.

18. The system of claim 15, wherein the programmed amount is less than the transition time.

19. The system of claim 14, wherein determining the value of the voltage oscillations includes determining that the voltage oscillations are at a first peak value at a first time and determining that the voltage oscillations are at a second peak value less than the first peak value at a second time, and wherein modifying the transition time of the control signal includes setting the transition time to equal a difference between the second time and the first time.

20. The system of claim 19, wherein the system is configured to begin a timer responsive to determining that the voltage oscillations are at the first peak value at the first time, and stop the timer responsive to determining that the voltage oscillations are at the second peak value at the second time, and wherein a count value of the timer is the difference between the second time and the first time.
